(19) United States
(12) Patent Application Publication
(10) Pub. No.: US 2024/0332702 A1
(43) Pub. Date: Oct. 3, 2024

(54) BATTERY PACK

(71) Applicant: HONDA MOTOR CO., LTD., Tokyo (JP)

(72) Inventors: Yu IEMURA, Saitama (JP); Ken Yasui, Saitama (JP); Satoru Kawabe, Saitama (JP); Masaaki Tatsuwaki, Saitama (JP)

(73) Assignee: HONDA MOTOR CO., LTD., Tokyo (JP)

(21) Appl. No.: 18/588,028

(22) Filed: Feb. 27, 2024

(30) Foreign Application Priority Data
Mar. 28, 2023 (JP) 2023-052074

(51) Int. Cl. H01M 50/242; B60L 50/60; B60L 50/64; H01M 50/249

(52) U.S. Cl. CPC H01M 50/242; B60L 50/64; B60L 50/66; H01M 50/249; H01M 2220/20

(57) ABSTRACT

A battery pack including a battery and a battery case is attached under a floor of a vehicle. The battery case includes a bottom plate and side frames. Each side frame includes a protection region, a vertical rib and a deformation region arranged in this order from inside to outside. The deformation region is provided with a first plate having a first buckling point and connected to a first portion of the vertical rib, a second plate having a second buckling point at a same position as the first buckling point in a vertical direction and connected to a second portion of the vertical rib, and a third plate connected to the first buckling point and a third portion of the vertical rib and located between the first and second portions. A length between the first and third portions is shorter than a length between the second and third portions.

### CROSS-REFERENCE TO RELATED APPLICATIONS

This application is based on and claims priority under 35 USC 119 from Japanese Patent Application No. 2023-052074 filed on Mar. 28, 2023, the entire content of which is incorporated herein by reference.

### TECHNICAL FIELD

The present disclosure relates to a battery pack to be mounted under a floor of a vehicle.

### BACKGROUND ART

In recent years, efforts to realize a low-carbon society or a decarbonized society become active, and research and development of electrification techniques are conducted to reduce CO2 emission and improve energy efficiency in vehicles.

Batteries play an important role in the electrification techniques. Since the battery is a high-voltage component, it is necessary to protect the battery from an impact. However, when the battery is mounted on a vehicle, a large load may be input to the battery in a collision or the like. In particular, in a battery pack mounted under a floor of a vehicle, an impact is absorbed in an engine room (motor room) or a luggage room at the time of a front collision or a rear collision, but a large load may be input to the battery pack at the time of a side collision.

In this regard, JP2022-154687A discloses that an energy absorption portion is provided outside a side wall portion of a battery case to protect a battery.

However, in the structure described in JP2022-154687A, when the side wall portion rotates inward toward the battery due to an impact that cannot be absorbed by the energy absorption portion, the side wall portion may collide with the battery because a distance between the side wall portion and the battery is short. Further, when the side wall portion rotates outward toward a side opposite to the battery, a bottom plate fixed to the side wall portion may be deformed toward the battery and the bottom plate may collide with the battery.

### SUMMARY OF INVENTION

The present disclosure provides a battery pack capable of appropriately protecting a battery from an impact from a vehicle lateral direction such as a side collision.

An aspect of the present disclosure relates to a battery pack to be attached under a floor of a vehicle, the battery pack including:
a battery; and
a battery case accommodating the battery,
in which the battery case includes:
   a bottom plate on which the battery is placed;
   a pair of side frames joined to the bottom plate and facing each other in a vehicle width direction; and
   a cross member connecting the pair of side frames,
each of the side frames includes:
   a vertical rib;
   a protection region provided on a battery side with respect to the vertical rib; and
   a deformation region provided on a side opposite to the battery with respect to the vertical rib,
the deformation region is provided with:
   a first plate-shaped portion having a first buckling point, and connected to a first connection portion of the vertical rib;
   a second plate-shaped portion having a second buckling point provided at a same position as the first buckling point when viewed in an upper-lower direction, and connected to a second connection portion of the vertical rib; and
   a third plate-shaped portion connected to the first buckling point and a third connection portion of the vertical rib, and located between the first connection portion and the second connection portion, and
a length between the first connection portion and the third connection portion is shorter than a length between the second connection portion and the third connection portion.

According to the present disclosure, it is possible to appropriately protect the battery from an impact from a vehicle lateral direction such as a side collision.

### BRIEF DESCRIPTION OF DRAWINGS

Exemplary embodiment(s) of the present invention will be described in detail based on the following figures, wherein:

FIG. 1 is a perspective view of a battery pack 1 and an electric vehicle 100 on which the battery pack 1 is mounted;

FIG. 2 is an exploded perspective view of the battery pack 1;

FIG. 3 is a plan view showing an internal structure of the battery pack 1;

FIG. 4 is a cross-sectional view taken along a line A-A of FIG. 3;

FIG. 5 is a diagram illustrating a deformation mode of a battery case 31 when a load in a vehicle lateral direction is input to the battery pack 1; and

FIG. 6 is a schematic diagram illustrating rotation of a triangle T formed by deformation.

### DESCRIPTION OF EMBODIMENTS

Hereinafter, a battery pack of an embodiment of the present disclosure is described based on the accompanying drawings.

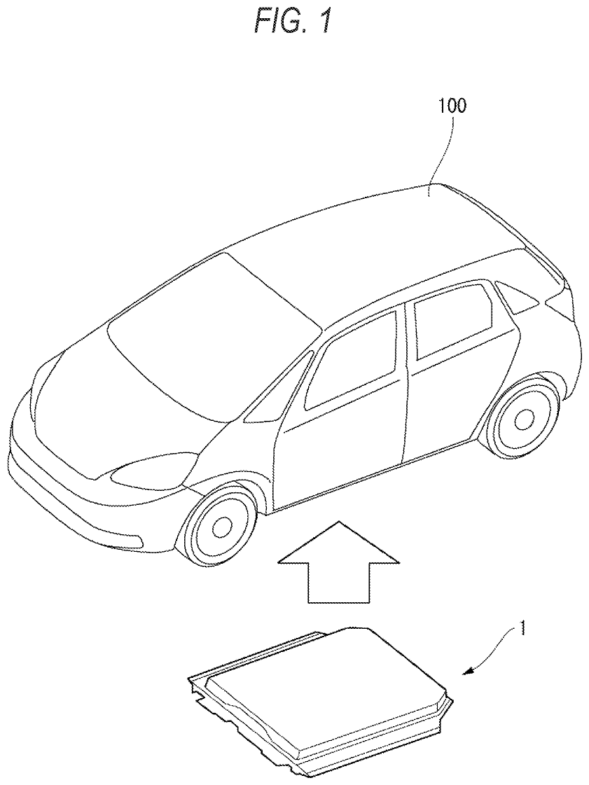

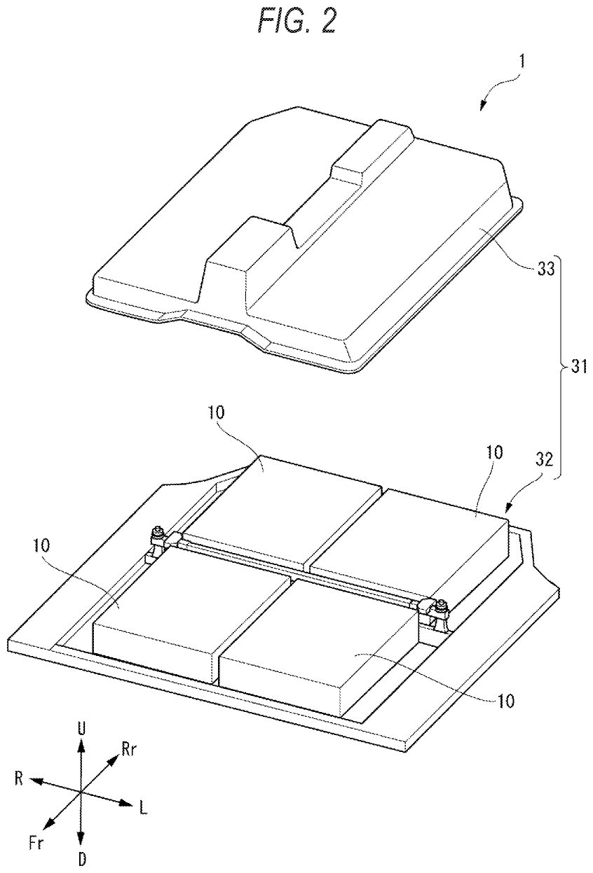

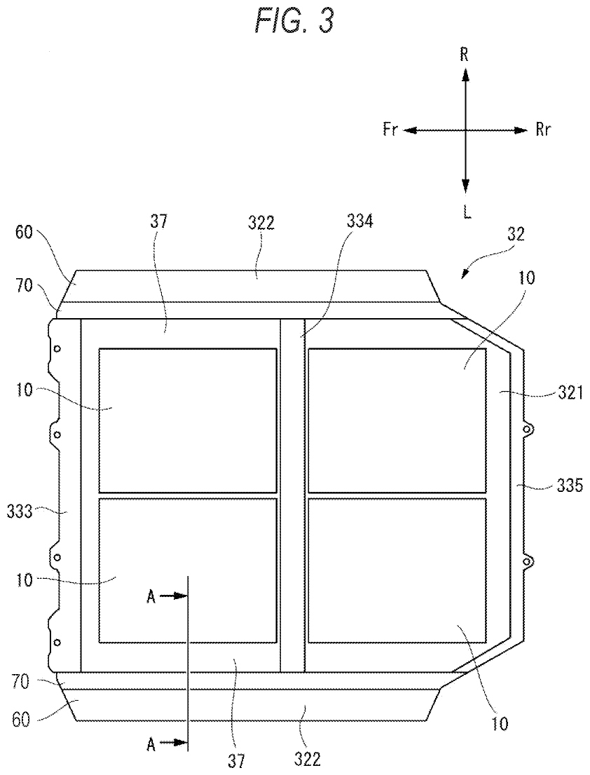

As shown in FIG. 1, a battery pack 1 according to an embodiment of the present disclosure is configured to be mounted under a floor of an electric vehicle 100 such as a hybrid vehicle, an electric automobile, or a fuel cell vehicle. As shown in FIGS. 2 and 3, the battery pack 1 includes four battery modules 10 and a battery case 31 that accommodates the four battery modules 10. The four battery modules 10 are arranged in two rows in a front-rear direction and in two rows in a left-right direction. The number of battery modules 10 can be freely set as long as the number is one or more, and an arrangement is also not particularly limited.

The battery modules 10 are electrically connected to one another via an electrical connection member (not shown). Electric power stored in the battery modules 10 is supplied to a motor or the like serving as a drive source of the vehicle. In the following description, the four battery modules 10 may be collectively referred to as a battery.

The battery module 10 is configured by stacking a plurality of laminated cells, for example. The laminated cell includes a positive electrode to which a positive electrode tab is connected, a negative electrode to which a negative electrode tab is connected, an electrolyte disposed between the positive electrode and the negative electrode, and a laminated film that accommodates the positive electrode, the negative electrode, and the electrolyte, and the laminated cell performs charging and discharging by transferring ions (for example, lithium ions) between the positive electrode and the negative electrode via the electrolyte. The cell constituting the battery module 10 is not limited to a laminate type, and may be a can type or a tube type, and the electrolyte may be liquid or solid.

The battery case 31 includes a battery tray 32 on which the plurality of battery modules 10 are placed, and an upper cover 33 that covers the battery modules 10 from above.

The battery tray 32 includes a bottom plate 321 on which the battery modules 10 are placed, a pair of side frames 322 provided on both left and right sides of the bottom plate 321, and a front cross member 333, a central cross member 334, and a rear cross member 335 that connect the pair of side frames 322.

The front cross member 333 constitutes a front wall of the battery case 31, and the rear cross member 335 constitutes a rear wall of the battery case 31. The central cross member 334 divides an interior of the battery case 31 into two front and rear spaces. Two battery modules 10 are disposed on the left and right in the front space, and two battery modules 10 are disposed on the left and right in the rear space.

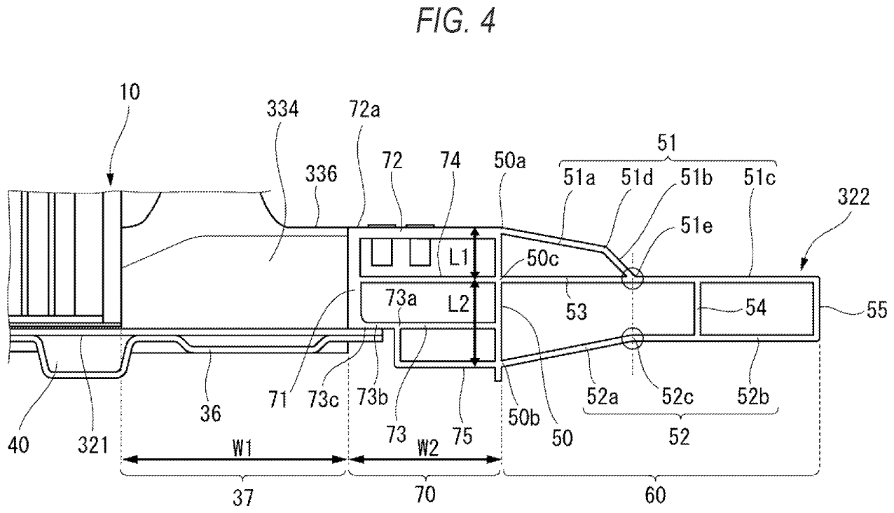

As shown in FIG. 4, a cover plate 36 is attached below the bottom plate 321, and a water jacket 40 is formed between the bottom plate 321 and the cover plate 36.

Hereinafter, the side frame 322 will be described in detail with reference to FIG. 4.

As shown in FIG. 4, the side frame 322 includes a vertical rib 50 having a predetermined height and extending in the front-rear direction, a deformation region 60 provided on an outer side with respect to the vertical rib 50, that is, on a side opposite to the battery, and a protection region 70 provided on an inner side with respect to the vertical rib 50, that is, on a battery side. Both the deformation region 60 and the protection region 70 have a function of protecting the battery from a load from a vehicle lateral direction, and the protection region 70 is a highly rigid region and receives an input load due to the rigidity. Meanwhile, the deformation region 60 absorbs the input load while being deformed.

The protection region 70 includes an inner frame 71 extending in a vertical direction and functioning as an inner wall of a battery accommodating space; an upper frame 72 extending in a horizontal direction and connecting an upper end of the inner frame 71 and an upper end of the vertical rib 50; a first middle plate 73 extending in the horizontal direction and connecting a lower end of the inner frame 71 and an intermediate portion of the vertical rib 50; a second middle plate 74 extending in the horizontal direction between the upper frame 72 and the first middle plate 73 and connecting the inner frame 71 and the vertical rib 50; and a lower plate 75 extending downward from a width-direction central portion 73a of the first middle plate 73, then bent outward to extend in the horizontal direction, and connected to a lower end of the vertical rib 50.

The inner frame 71 and the upper frame 72 are thicker and more rigid than other portions. The front cross member 333, the central cross member 334, and the rear cross member 335 are joined to the inner frame 71 by welding or the like. Here, an upper surface 72a of the inner frame 71 and upper surfaces 336 of the cross members 333 to 335 are set to have the same height in an upper-lower direction.

The bottom plate 321 and the cover plate 36 are attached to a lower surface of an inner portion 73b of the first middle plate 73, which is located inward than the width-direction central portion 73a, by welding or the like. Hereinafter, a fixing portion between the inner portion 73b of the first middle plate 73 and the bottom plate 321 is referred to as a joint portion 73c.

Accordingly, when the protection region 70 of the side frame 322 rotates inward (hereinafter also referred to as “inward rotation”), the bottom plate 321 and the cover plate 36 are deformed downward accordingly, and conversely, when the protection region 70 of the side frame 322 rotates outward (hereinafter also referred to as “outward rotation”), the bottom plate 321 and the cover plate 36 are deformed upward accordingly. When being deformed upward, the bottom plate 321 and the cover plate 36 may interfere with the battery mounted on the bottom plate 321.

A predetermined gap is formed in the left-right direction between the inner frame 71 and the battery mounted on the bottom plate 321. A region extending in the front-rear direction on an outer side with respect to the battery functions as a crush stroke portion 37. In other words, the protection region 70 of the side frame 322 is provided at a peripheral edge of the crush stroke portion 37, and the bottom plate 321 is joined to the side frame 322 at the protection region 70.

Although to be described in detail later, a width W1 of the crush stroke portion 37 is set such that a member constituting the protection region 70 does not come into contact with the battery even when the protection region 70 of the side frame 322 rotates inward. The width W1 of the crush stroke portion 37 is preferably larger than a width W2 of the protection region 70 of the side frame 322.

The deformation region 60 includes a first plate-shaped portion 51 extending outward from a first connection portion 50a at the upper end of the vertical rib 50, a second plate-shaped portion 52 extending outward from a second connection portion 50b at the lower end of the vertical rib 50, a third plate-shaped portion 53 extending outward from a third connection portion 50c at the intermediate portion of the vertical rib 50 and connected to the first plate-shaped portion 51, and an inner wall portion 54 and an outer wall portion 55 extending in the vertical direction and connecting the first plate-shaped portion 51 and the second plate-shaped portion 52.

The first plate-shaped portion 51 includes a gently inclined portion 51a extending outward and obliquely downward from the first connection portion 50a at the upper end of the vertical rib 50, a steeply inclined portion 51b extending obliquely downward at a steeper inclination than the gently inclined portion 51a, an upper horizontal portion 51c disposed outward than the steeply inclined portion 51b and extending outward in the horizontal direction, a first bent portion 51d connecting the gently inclined portion 51a and the steeply inclined portion 51b, and a second bent portion 51e connecting the steeply inclined portion 51b and the upper horizontal portion 51c. The second bent portion 51e is located upward than the joint portion 73c.

The second plate-shaped portion 52 includes an inclined portion 52a extending outward and obliquely upward from the second connection portion 50b at the lower end of the vertical rib 50, a lower horizontal portion 52b disposed outward than the inclined portion 52a and extending outward in the horizontal direction, and a lower bent portion 52c connecting the inclined portion 52a and the lower horizontal portion 52b.

The third plate-shaped portion 53 extends outward from the third connection portion 50c in a manner of being located on an extension line of the second middle plate 74 of the protection region 70, and is connected to the second bent portion 51e of the first plate-shaped portion 51.

The first connection portion 50a, the third connection portion 50c, and the second connection portion 50b are disposed in this order from above. A length L1 between the first connection portion 50a and the third connection portion 50c is shorter than a length L2 between the second connection portion 50b and the third connection portion 50c. The length L1 may be shorter than the length L2, and is preferably half or less.

The second bent portion 51e, to which the first plate-shaped portion 51 and the third plate-shaped portion 53 are connected, and the lower bent portion 52c of the second plate-shaped portion 52 are disposed at the same position in the left-right direction, that is, at a position of being overlapped with each other when viewed from above. The inner wall portion 54 connects the first plate-shaped portion 51 and the second plate-shaped portion 52 on an outer side with respect to the second bent portion 51e and the lower bent portion 52c, and the outer wall portion 55 connects an outer end portion of the first plate-shaped portion 51 and an outer end portion of the second plate-shaped portion 52 on a further outer side with respect to the inner wall portion 54.

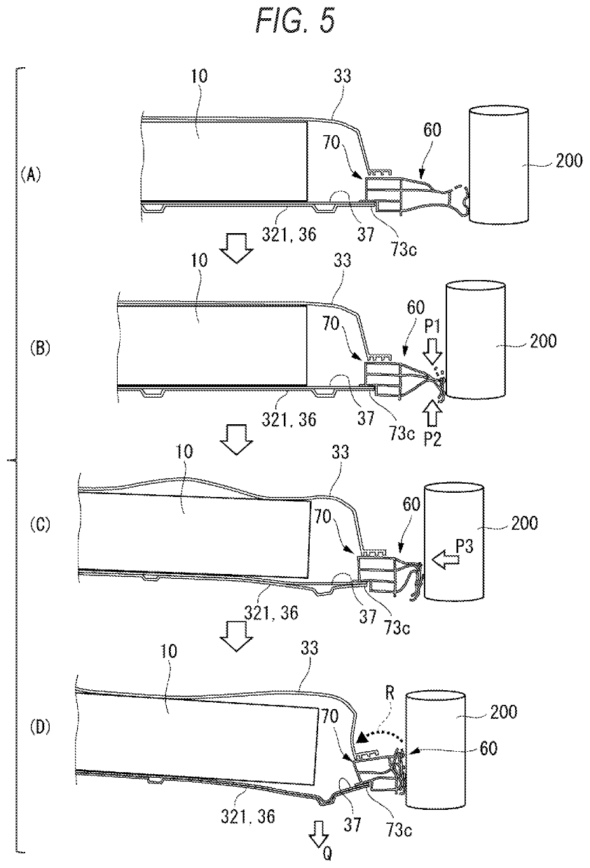

Next, a deformation mode of the side frame 322 configured as described above will be described. FIG. 5 is a diagram illustrating a deformation mode of the battery case 31 when a load in a vehicle lateral direction is input to the battery pack 1. Reference numeral 200 in FIG. 5 denotes a columnar impact input member.

When a load in the vehicle lateral direction is input to the side frame 322 due to a collision (primary collision), crushing deformation starts in the deformation region 60. As shown in (A) of FIG. 5, when the outer wall portion 55 is pushed inward, a load acts such that the first plate-shaped portion 51 and the second plate-shaped portion 52 are deformed such that an upper-lower distance therebetween increases between the inner wall portion 54 and the outer wall portion 55, and the upper-lower distance between the first plate-shaped portion 51 and the second plate-shaped portion 52 decreases on an inner side with respect to the inner wall portion 54.

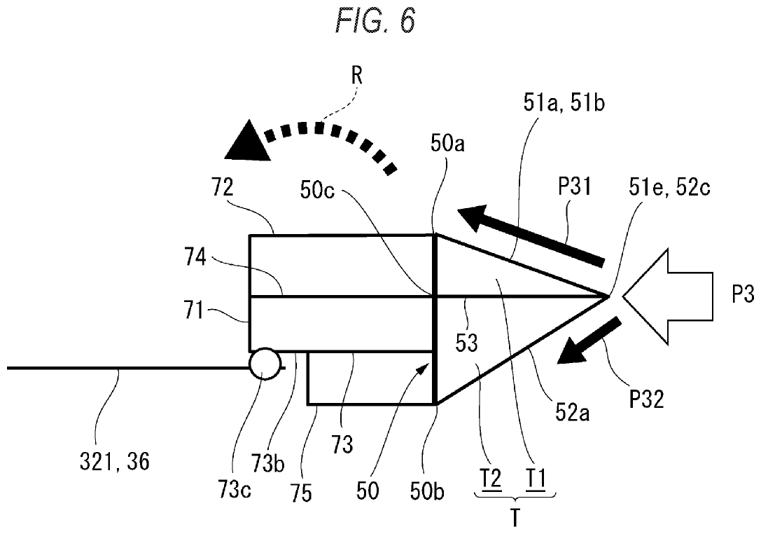

Further, when a load in the vehicle lateral direction is input to the side frame 322, as shown in (B) of FIG. 5, due to a downward load applied to the first plate-shaped portion 51 and indicated by an arrow P1, the first plate-shaped portion 51 is buckled with the second bent portion 51e as a buckling point. Further, due to an upward load applied to the second plate-shaped portion 52 and indicated by an arrow P2, the second plate-shaped portion 52 is buckled with the lower bent portion 52c as a buckling point. At this time, since the second bent portion 51e and the lower bent portion 52c are disposed at the same position in the left-right direction (the position overlapped with each other when viewed from above), a secondary collision occurs in which the second bent portion 51e and the lower bent portion 52c are deformed to approach each other and collide with each other. As a result, as shown in (C) of FIG. 5 and FIG. 6, in the deformation region 60, a triangle T having the vertical rib 50, the gently inclined portion 51a and the steeply inclined portion 51b of the first plate-shaped portion 51, and the inclined portion 52a of the second plate-shaped portion 52 as three sides is generated. The triangle T is a triangle having the first connection portion 50a, the second connection portion 50b, and the second bent portion 51e and the lower bent portion 52c which collide with each other as vertices.

The triangle T includes two triangles T1 and T2. The first triangle T1 is a triangle having the vertical rib 50 between the first connection portion 50a and the third connection portion 50c, the gently inclined portion 51a and the steeply inclined portion 51b of the first plate-shaped portion 51, and the third plate-shaped portion 53 as three sides. That is, the first triangle T1 is a triangle having the first connection portion 50a, the third connection portion 50c, and the second bent portion 51e and the lower bent portion 52c that collide with each other as vertices.

The second triangle T2 is a triangle having the vertical rib 50 between the second connection portion 50b and the third connection portion 50c, the inclined portion 52a, and the third plate-shaped portion 53 as three sides. That is, the second triangle T2 is a triangle having the second connection portion 50b, the third connection portion 50c, and the second bent portion 51e and the lower bent portion 52c that collide with each other as vertices.

Since the length L1 between the first connection portion 50a and the third connection portion 50c is set to be shorter than the length L2 between the second connection portion 50b and the third connection portion 50c, an area of the first triangle T1 is smaller than an area of the second triangle T2. In other words, in the triangle T, an upper portion (the first triangle T1) has a dense cross section, and a lower portion (the second triangle T2) has a sparse cross section. When the cross section is dense, crushing due to a load is less likely to occur, and the load is likely to be transmitted. On the other hand, when the cross section is sparse, crushing due to a load is likely to occur, and the load is less likely to be transmitted. Therefore, due to the load in the vehicle lateral direction acting on the side frame 322, a large load is transmitted through the triangle T1 and presses the protection region 70. An arrow P31 in FIG. 6 indicates a load acting on the triangle T1 in a load P3 in the vehicle lateral direction acting on the side frame 322, and an arrow P32 indicates a load acting on the triangle T2 in the load P3 in the vehicle lateral direction acting on the side frame 322. The load P31 is larger than the load P32.

Accordingly, the load P3 in the vehicle lateral direction acting on the side frame 322 acts to push the first triangle T1 inward. Since the first triangle T1 is located upward than the joint portion 73c, the first triangle T1 is pushed inward, and thus the protection region 70 rotates inward around the joint portion 73c as indicated by a dotted line R.

As shown in (D) of FIG. 5, since the protection region 70 of the side frame 322 rotates inward, the bottom plate 321 and the cover plate 36 fixed to the inner portion 73b of the first middle plate 73 are pulled downward in a direction away from the battery as indicated by an arrow Q. Accordingly, deforming of the bottom plate 321 toward the battery and collision of the bottom plate 321 with the battery are avoided.

As described above, according to the present disclosure, due to the control of the rotation of the side frame 322 caused by energy that cannot be absorbed by the deformation of the deformation region 60, it is possible to appropriately protect the battery from an impact from the vehicle lateral direction such as a side collision. That is, when an impact such as a side collision is input from the vehicle lateral direction, the buckling points (the second bent portion 51e and the lower bent portion 52c) collide with each other due to the deformation of the deformation region 60, and thus energy can be efficiently absorbed. After the secondary collision of the buckling points (the second bent portion 51e and the lower bent portion 52c), the buckling points (the second bent portion 51e and the lower bent portion 52c) located upward than the joint portion 73c are pushed in the horizontal direction or upward from the horizontal direction by the energy that cannot be absorbed, and thus the protection region 70 of the side frame 322 rotates in a direction approaching the battery module 10. Since the side frame 322 rotates to an inside of the battery case 31, the side frame 322 pushes the bottom plate 321 downward, and the bottom plate 321 is prevented from bending toward the battery module 10. Accordingly, the battery can be appropriately protected from an impact from the vehicle lateral direction such as a side collision.

Further, since the upper surface 72a of the inner frame 71 and the upper surfaces 336 of the cross members 333 to 335 are set to have the same height in the upper-lower direction, a deformation amount of the entire side frame 322 is reduced, and a rotation amount of the side frame 322 is also reduced.

Further, since the peripheral edge of the crush stroke portion 37 is joined to the side frame 322 at the protection region 70 of the side frame 322, a weight of the bottom plate 321 can be reduced as compared with a case where the bottom plate 321 is extended to the deformation region 60. In addition, the rotation of the side frame 322 is easily controlled as compared with a case where the bottom plate 321 is extended to the deformation region 60. Further, even when an input load is large and the bottom plate 321 is deformed, the crush stroke portion 37 is deformed to project downward, thereby making it possible to protect the battery while absorbing the input load.

Although various embodiments have been described above with reference to the drawings, the present invention is not limited thereto. It is apparent that those skilled in the art can conceive of various modifications and changes within the scope described in the claims, and it is understood that such modifications and changes naturally fall within the technical scope of the present invention. In addition, constituent elements in the embodiment described above may be freely combined without departing from the gist of the present invention.

In this specification, at least the following matters are described. In the parentheses, the corresponding constituent elements and the like are illustrated in the above embodiment, but the present invention is not limited thereto.

(1) A battery pack (battery pack 1) to be attached under a floor of a vehicle (electric vehicle 100), the battery pack including:
a battery (battery module 10); and
a battery case (battery case 31) accommodating the battery,
in which the battery case includes:
   a bottom plate (bottom plate 321) on which the battery is placed;
   a pair of side frames (side frames 322) joined to the bottom plate and facing each other in a vehicle width direction; and
   a cross member (front cross member 333, central cross member 334, and rear cross member 335) connecting the pair of side frames,
each of the side frames includes:
   a vertical rib (vertical rib 50);
   a protection region (protection region 70) provided on a battery side with respect to the vertical rib; and
   a deformation region (deformation region 60) provided on a side opposite to the battery with respect to the vertical rib,
the deformation region is provided with:
   a first plate-shaped portion (first plate-shaped portion 51) having a first buckling point (second bent portion 51e), and connected to a first connection portion (first connection portion 50a) of the vertical rib;
   a second plate-shaped portion (second plate-shaped portion 52) having a second buckling point (lower bent portion 52c) provided at a same position as the first buckling point when viewed in an upper-lower direction, and connected to a second connection portion (second connection portion 50b) of the vertical rib; and
   a third plate-shaped portion (third plate-shaped portion 53) connected to the first buckling point and a third connection portion (third connection portion 50c) of the vertical rib, and located between the first connection portion and the second connection portion, and
a length (length L1) between the first connection portion and the third connection portion is shorter than a length (length L2) between the second connection portion and the third connection portion.

According to the above (1), when a collision from a vehicle lateral direction (primary collision), that is, a so-called side collision occurs, a secondary collision occurs between the buckling points, and thus energy can be efficiently absorbed. Further, the buckling point located upward than a joint portion between the bottom plate and the side frame is pushed inward by the energy that cannot be absorbed after the secondary collision of the buckling points, and thus the protection region of the side frame rotates in a direction approaching the battery. Since the side frame rotates to an inside of the battery case, the side frame pushes the bottom plate downward, so that the bottom plate is prevented from bending toward the battery. As described above, due to control of the rotation of the side frame caused by the energy that cannot be absorbed by the deformation of the deformation region, it is possible to appropriately protect the battery from an impact from the vehicle lateral direction such as a side collision.

(2) The battery pack according to (1),
in which the cross member includes at least one of:
   a front cross member (front cross member 333) located at a front portion of the battery pack;
   a rear cross member (rear cross member 335) located at a rear portion of the battery pack; or
   a middle cross member (central cross member 334) located between the front cross member and the rear cross member,
each of the cross members and the side frames are joined to each other, and
an upper surface (upper surface 336) of each of the cross members and an upper surface (upper surface 72a) of the protection region of the side frame have a same height in the upper-lower direction at a position where the cross member and the side frames are joined to each other.

According to the above (2), a deformation amount of the entire side frame is reduced, and a rotation amount of the side frame is also reduced.

(3) The battery pack according to (1) or (2),
in which the bottom plate includes a crush stroke portion (crush stroke portion 37) extending in a vehicle front-rear direction on an outer side with respect to the battery, and
a peripheral edge of the crush stroke portion is joined to the side frame at the protection region of the side frame.

According to the above (3), a weight of the bottom plate can be reduced as compared with a case where the bottom plate is extended to the deformation region. In addition, the rotation of the side frame is easily controlled as compared with the case where the bottom plate is extended to the deformation region. Further, even when an input load is large and the bottom plate is deformed, since the inward rotating side frame and the peripheral edge of the crush stroke portion of the bottom plate are joined to each other, the crush stroke portion is deformed to project downward. Accordingly, it is possible to protect the battery while absorbing the input load.

(4) The battery pack according to (3),
in which a width (width W1) of the crush stroke portion is larger than a width (width W2) of the protection region of the side frame.

According to the above (4), when the side frame rotates to an inside of the case, the side frame can be prevented from interfering with the battery.

What is claimed is:

1. A battery pack to be attached under a floor of a vehicle, the battery pack comprising:
a battery; and
a battery case accommodating the battery,
wherein the battery case includes:
a bottom plate on which the battery is placed;
a pair of side frames joined to the bottom plate and facing each other in a vehicle width direction; and
a cross member connecting the pair of side frames,
each of the side frames includes:
a vertical rib;
a protection region provided on a battery side with respect to the vertical rib; and
a deformation region provided on a side opposite to the battery with respect to the vertical rib,
the deformation region is provided with:
a first plate-shaped portion having a first buckling point, and connected to a first connection portion of the vertical rib;
a second plate-shaped portion having a second buckling point provided at a same position as the first buckling point when viewed in an upper-lower direction, and connected to a second connection portion of the vertical rib; and
a third plate-shaped portion connected to the first buckling point and a third connection portion of the vertical rib, and located between the first connection portion and the second connection portion, and
a length between the first connection portion and the third connection portion is shorter than a length between the second connection portion and the third connection portion.

2. The battery pack according to claim 1,
wherein the cross member includes at least one of:
a front cross member located at a front portion of the battery pack;
a rear cross member located at a rear portion of the battery pack; or
a middle cross member located between the front cross member and the rear cross member,
each of the cross members and the side frames are joined to each other, and
an upper surface of each of the cross members and an upper surface of the protection region of the side frame have a same height in the upper-lower direction at a position where the cross member and the side frames are joined to each other.

3. The battery pack according to claim 1,
wherein the bottom plate includes a crush stroke portion extending in a vehicle front-rear direction on an outer side with respect to the battery, and
a peripheral edge of the crush stroke portion is joined to the side frame at the protection region of the side frame.

4. The battery pack according to claim 3,
wherein a width of the crush stroke portion is larger than a width of the protection region of the side frame.
